(19) United States
(12) Patent Application Publication
(10) Pub. No.: US 2013/0201129 A1
(43) Pub. Date: Aug. 8, 2013

(54) INFORMATION PROCESSING APPARATUS, INFORMATION PROCESSING METHOD, AND PROGRAM

(71) Applicant: Sony Corporation, Tokyo (JP)

(72) Inventors: Shinji Inamoto, Tokyo (JP); Shinya Masunaga, Tokyo (JP); Katsutoshi Ishiwata, Kanagawa (JP); Akihiro Komori, Tokyo (JP); Tomoaki Takemura, Tokyo (JP); Daisuke Ogata, Saitama (JP)

(73) Assignee: Sony Corporation, Tokyo (JP)

(21) Appl. No.: 13/749,802

(22) Filed: Jan. 25, 2013

(30) Foreign Application Priority Data
Feb. 3, 2012 (JP) 2012-021891

(51) Int. Cl. G06F 3/041

(52) U.S. Cl. CPC G06F 3/041
USPC 345/173

(57) ABSTRACT

There is provided an information processing apparatus including a position detecting unit detecting a contact position at which an input object has touched a touch panel, an area detecting unit detecting a contact area between the touch panel and the input object, and a selecting unit selecting any one of a plurality of objects based on the contact position and the contact area.

### BACKGROUND

The present disclosure relates to an information processing apparatus, an information processing method, and a program.

Along with the spread of smartphones and the expansion in network connectivity, technologies for treating a touch panel-equipped terminal as a controller for controlling a TV set, a game console, or the like have been provided. However, since hardware buttons are not present on a touch panel, it is easy for users to press the wrong button, especially in situations where the user is not looking at the controller, such as when playing a game. For this reason, when a user makes operations using a touch panel, the user will sometimes momentarily glance at the controller to prevent large positional displacements from occurring between the position of the button the user wishes to press and the position actually touched by the user. Note that the “buttons” referred to here are one example of objects.

Technologies for preventing such positional displacements include technologies that provide the user with a virtual haptic sensation through the use of vibration, for example. However, such technologies can only be applied in devices with a function for generating vibration. For normal devices, there is also a technology for enlarging and reducing the recognition regions used to recognize objects selected using a touch panel and a technology for shifting such regions.

As one example, there is a technology that shifts a recognition region for recognizing a selected object according to the position where an object is disposed (see for example Japanese Laid-Open Patent Publication No. 2011-175456). Since it is difficult to select an object disposed at a lower end of a touch panel of a copier, for example, this technology shifts the recognition region upward. If the recognition region is shifted in this way, an object may be selected even if the position touched by the user is displaced from the position of the object the user intended to select.

### SUMMARY

Although the technology disclosed in the cited publication is effective when the displacement between the position touched by the user and the position of the object the user wishes to select is constant, such displacement is sometimes not constant. For example, when a touch panel is used as a controller, since it is necessary to select objects multiple times in a short time without looking at the touch panel, the displacement may change. This means it is difficult to recognize the object the user intended to select by merely shifting the recognition region in a uniform manner.

Also, even if the recognition region is shifted in a uniform manner, there is the possibility that the position touched by the user will become increasingly displaced from an object position and that the user will touch a position midway between a plurality of objects, for example. Such possibility is especially high when a controller equipped with a touch panel is used since it is common for users to make operations without looking at the panel.

For the reasons given above, there is demand for a technology for improving accuracy when selecting a user's intended object. As examples, it is desirable to improve accuracy even when selecting a user's intended object when there is a large displacement between the position of an object and the position touched by the user and when the user touches a position midway between a plurality of objects.

According to an embodiment of the present disclosure, there is provided an information processing apparatus including a position detecting unit detecting a contact position at which an input object has touched a touch panel, an area detecting unit detecting a contact area between the touch panel and the input object, and a selecting unit selecting any one of a plurality of objects based on the contact position and the contact area.

Further, according to an embodiment of the present disclosure, there is provided an information processing method including detecting a contact position at which an input object has touched a touch panel, detecting a contact area between the touch panel and the input object, and selecting any one of a plurality of objects based on the contact position and the contact area.

Further, according to an embodiment of the present disclosure, there is provided a program for causing a computer to function as an information processing apparatus, the information processing apparatus including a position detecting unit detecting a contact position at which an input object has touched a touch panel, an area detecting unit detecting a contact area between the touch panel and the input object, and a selecting unit selecting any one of a plurality of objects based on the contact position and the contact area.

According to the embodiments of the present disclosure described above, it is possible to improve accuracy when selecting a user's intended object.

### BRIEF DESCRIPTION OF THE DRAWINGS

FIG. 1 is a diagram showing an example of a usage state of an information processing apparatus according to an embodiment of the present disclosure;

FIG. 2 is a diagram showing another example of a usage state of the information processing apparatus;

FIG. 3 is a block diagram showing an example functional configuration of the information processing apparatus;

FIG. 4 is a diagram showing an example layout of a plurality of buttons by the information processing apparatus;

FIG. 5 is a diagram showing an example correction of the contact area;

FIG. 6 is a diagram showing an example of how the coefficients that correspond to the respective buttons are decided;

FIG. 7 is a diagram showing one example of calculation of scores corresponding to the respective buttons;

FIG. 8 is a flowchart showing the flow of operation by the information processing apparatus;

FIG. 9 is a diagram showing another example of deciding the coefficients corresponding to the respective buttons; and

FIG. 10 is a diagram showing another example of calculation of scores corresponding to buttons.

### DETAILED DESCRIPTION OF THE EMBODIMENT(S)

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

Also, in this specification and the drawings, in some cases a plurality of structural elements that have substantially the same function and structure are distinguished by different letters that have been appended to the same reference numerals. However, when it is not especially necessary to distinguish between such plurality of structural elements with effectively the same function and structure, only the same reference numerals are used.

Preferred embodiments of the present disclosure will now be described in the order indicated below.
1. Usage State of Information Processing Apparatus
2. Example of Functions of Information Processing Apparatus
3. Operation of Information Processing Apparatus
4. Another Example of Functions of Information Processing Apparatus
5. Conclusion

### 1. Usage State of Information Processing Apparatus

According to the present embodiment of the disclosure, it is possible to improve accuracy when selecting a user's intended object out of a plurality of objects displayed on a touch panel. For example, it is possible to improve the accuracy when selecting a user's intended object even when a user makes an input on a touch panel without looking at the touch panel and there is a large displacement between the object the user wishes to select and the position touched by the user or the user selects a position midway between a plurality of objects. In particular, in the present embodiment of the disclosure, by focusing on the way in which touch panels are touched by people, a technology for improving accuracy when selecting a user's intended object is realized.

Note that although an example where a device selects which button has been pressed by a user in order to select an object is described below, the selection of an object is not limited to the selection of a button pressed by the user and may be selection of an object aside from a button, such as an icon. The characteristics of how touch panels are touched by people will be described first. When a touch panel-equipped terminal (for example, a terminal of approximately the same size as a smartphone) is used as a controller, although there are exceptions, such terminal will usually be held in both hands near the base of the index fingers and operated using the thumbs. In such case, the state of a thumb which touches the touch panel will differ according to the position of the button the user wishes to press.

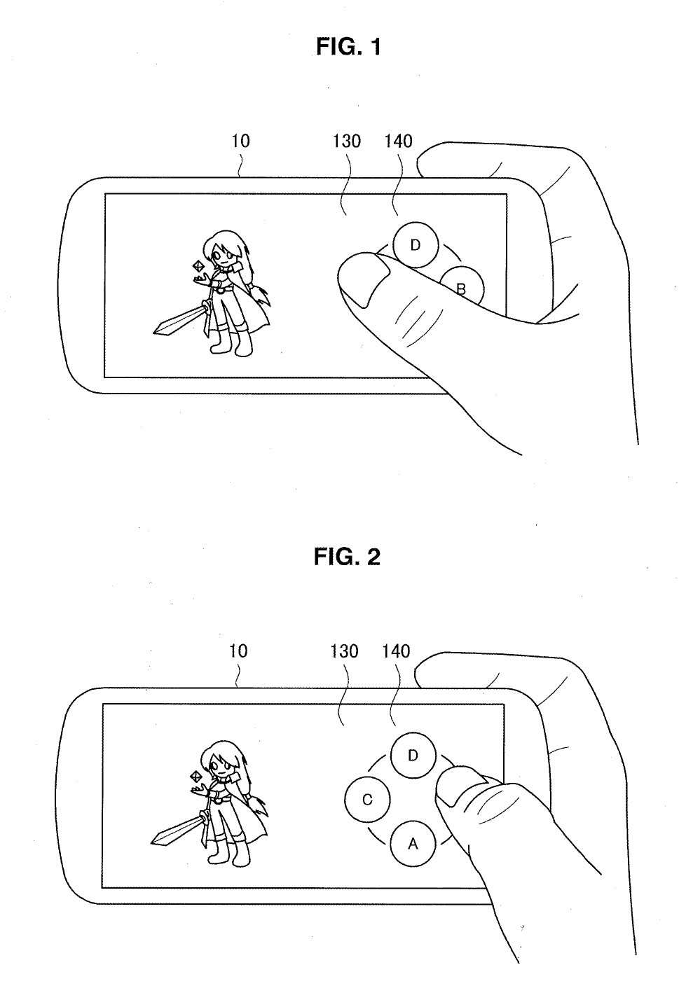

FIG. 1 is a diagram showing an example of a usage state of an information processing apparatus 10 according to an embodiment of the present disclosure. FIG. 2 is a diagram showing another example of a usage state of the information processing apparatus 10 according to the same embodiment. The information processing apparatus 10 is one example of a touch panel-equipped terminal and although an example where a touch panel 130 and a display unit 140 are provided on the information processing apparatus 10 is shown in FIGS. 1 and 2, the touch panel 130 and the display unit 140 may be present outside the information processing apparatus 10. Also, although a state where the touch panel 130 and the display unit 140 are provided on top of one another is shown in FIGS. 1 and 2, the touch panel 130 and the display unit 140 may be separate.

Also, although four buttons, button A, button B, button C, and button D, to be pressed by the user are displayed on the display unit 140 in the example in FIGS. 1 and 2, the number of buttons is not especially limited to this. Also, as described above, it is also possible to display other objects aside from buttons on the display unit 140. In the present embodiment, an application is executed in accordance with the button pressed by the user and an execution result of the application is then displayed.

Although the execution result of the application is displayed on the display unit 140 in the example shown in FIGS. 1 and 2, the execution result of the application may be displayed on a different display unit to the display unit 140. Although there are no particular limitations on the type of application, FIGS. 1 and 2 show an example where the application is a game and a game execution screen is displayed on the display unit 140.

Here, in the example shown in FIG. 1, in an attempt to press a button at a position a certain distance or further from a lower right corner of the screen using the thumb of his/her right hand, the user touches the touch panel 130 with the pad of the right thumb in a state where the first joint of the right thumb is extended. Meanwhile, in the example in FIG. 2, in an attempt to press a button that is not far from the bottom right corner of the screen using the right thumb, the user touches the touch panel 130 with the tip of the thumb in a state where the first joint of the right thumb is bent.

In this way, when a person uses a touch panel-equipped terminal as a controller, the way in which the touch panel is touch tends to change according to the position of the button the user is attempting to press. In particular, when operations are made with the thumbs in a state where the terminal is held at the base of the index fingers, there is a tendency for users to adjust the pressed position by unconsciously bending and extending the first joint of the thumb. Even when a user who is attempting to press a button located not far from the bottom right corner of the screen instead presses a gap between buttons, there is still a high probability that the user will bend the first joint of the thumb and touch the touch panel with the tip of the thumb.

By considering such tendency, when there is displacement in the contact position on the touch panel 130, it is possible to infer which button the user intended to press according to the way in which the touch panel 130 was touched. Such a displacement is especially likely to occur if the user attempts to press a button without looking at the controller, for example. In more detail, since the contact area on the touch panel 130 is larger when the touch panel 130 is touched by the pad of a finger compared to when the panel is touched by the tip of a finger, it is possible to determine the way the touch panel 130 was touched according to the contact area.

By further taking into account the pressure applied to the touch panel 130 when the user contacts the touch panel 130, it is possible to improve accuracy in determining how the panel was touched. In more detail, the contact area tends to increase as the applied pressure increases, and this is also taken into account when making the determination. It is also possible to improve the accuracy of determinations by using characteristic information for an individual user and/or characteristic information for various usage states acquired by carrying out calibration. More specifically, characteristics such as an increase in contact area and/or an increase in pressure when a specified button is pressed by a certain user can be given as such characteristic information.

Characteristics showing how the contact area and/or pressure change according to conditions such as whether the user is making a gentle operation, a sudden reactive operation, or a rapid pounding operation can also be given as such characteristic information. Note that such characteristic information can be obtained in advance by having the user play a simple mini game or the like and can be obtained from the normal operations made by the user.

Note that there is existing technology for detecting whether a touch has been made with the pad of a user's finger or the tip of the finger based on the contact area and determining an input operation in accordance with the detection result. For example, there is a technology that determines that an operation for following a link has been made in a Web browser on detecting that the user has made contact using the tip of a finger and determines that an operation for scrolling the screen has been made on detecting that the user has made contact using the pad of a finger.

Meanwhile, the technology according to an embodiment of the present disclosure differs to such existing technology by having a premise of the user making an input on a touch panel without looking at the touch panel and correcting a displacement in the touched position based on the way in which the user's finger touches the panel. If such existing technology were adopted in a controller, a pressing of the A button would be recognized when the user has pressed using the tip of the finger and a pressing of the C button would be recognized when the user has pressed using the pad of the finger.

This completes the description of the characteristics of how touch panels are touched by people. Next, the functions of the information processing apparatus 10 according to the present embodiment of the disclosure will be described.

### 2. Example of Functions of Information Processing Apparatus

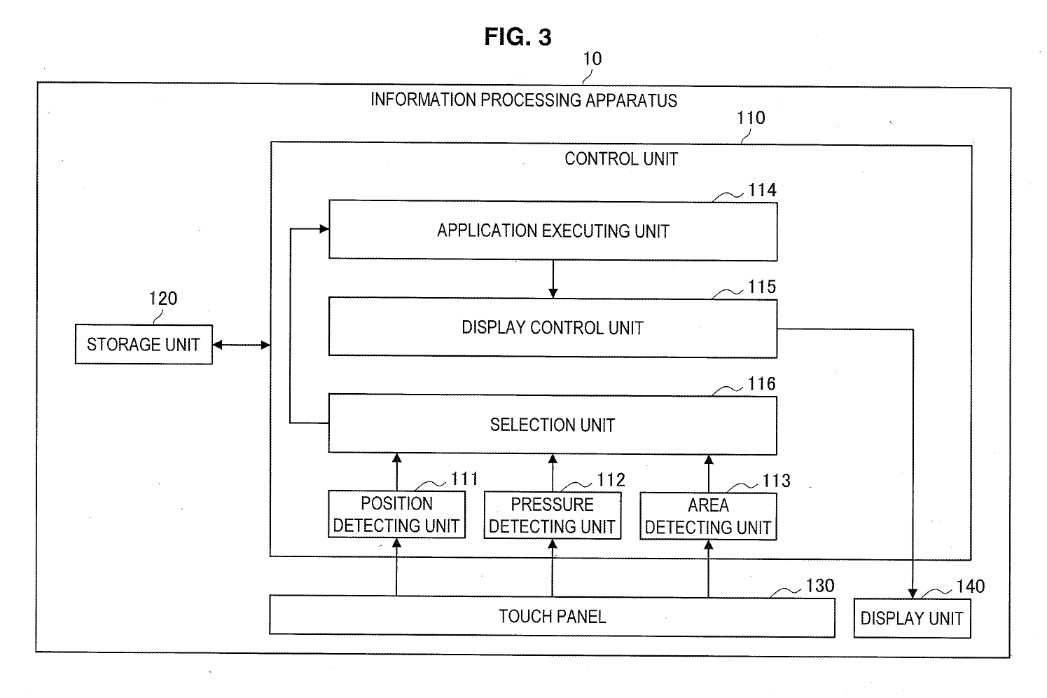

FIG. 3 is a block diagram showing an example functional configuration of the information processing apparatus 10 according to the present embodiment of the disclosure. As shown in FIG. 3, the information processing apparatus 10 includes a control unit 110, a storage unit 120, the touch panel 130, and the display unit 140. The control unit 110 includes a position detecting unit 111, a pressure detecting unit 112, an area detecting unit 113, an application executing unit 114, a display control unit 115, and a selection unit 116.

The control unit 110 corresponds to a processor such as a CPU (Central Processing Unit) or a DSP (Digital Signal Processor). By executing a program stored in the storage unit 120 or on another storage medium, the control unit 110 is capable of realizing the various functions of the control unit 110.

The storage unit 120 uses a storage medium such as a semiconductor memory or a hard disk drive and stores programs and data for processing by the control unit 110. As one example, it is possible for the storage unit 120 to also store an application to be executed by the application executing unit 114. It is also possible for the storage unit 120 to store a history of input information or the like. Although the storage unit 120 is incorporated in the information processing apparatus 10 in the example shown in FIG. 3, the storage unit 120 may be constructed separately to the information processing apparatus 10.

The touch panel 130 detects a contact position of an input object. If the touch panel 130 includes a pressure sensor, the pressure applied by the input object may be detected by the pressure sensor. Such detection result is outputted to the control unit 110. The expression “input object” is imagined here to refer to the user's thumb, but is not limited to such. As described above, the touch panel 130 may be included in the information processing apparatus 10 or may be present outside the information processing apparatus 10.

The position detecting unit 111 detects the contact position of the input object on the touch panel 130. More specifically, the contact position of the input object outputted from the touch panel 130 is detected by the position detecting unit 111. The contact position detected by the position detecting unit 111 is outputted to the selection unit 116 and is used to select the button pressed by the user. Note that the contact position detected by the position detecting unit 111 may be used by the area detecting unit 113 to detect the contact area. The contact position detected by the position detecting unit 111 corresponds to one example of the “input information”.

The pressure detecting unit 112 detects the pressure of the input object on the touch panel 130. In more detail, the pressure outputted from the touch panel 130 is detected by the pressure detecting unit 112. The pressure detected by the pressure detecting unit 112 is outputted to the selection unit 116 and may be used to select the button pressed by the user. The pressure detected by the pressure detecting unit 112 corresponds to one example of the “input information”.

The area detecting unit 113 detects the contact area of the contact between the input object and the touch panel 130. More specifically, the contact area for the contact between the input object and the touch panel 130 may be detected from a set of contact positions of the input object outputted from the touch panel 130. The contact area detected by the area detecting unit 113 is outputted to the selection unit 116 and is used to select the button pressed by the user. The contact area detected by the area detecting unit 113 corresponds to one example of the “input information”.

The selection unit 116 selects one of a plurality of buttons based on the contact position detected by the position detecting unit 111 and the contact area detected by the area detecting unit 113. The selected button is outputted to the application executing unit 114 as a button pressed by the user. More specifically, the respective positions of the plurality of buttons on the touch panel 130 may be set by an operating system or may be set by an application.

The selection unit 116 selects one out of the plurality of buttons based on the set positions of the respective buttons and the contact area. The selection unit 116 may select one out of the plurality of buttons also based on the pressure detected by the pressure detecting unit 112. In addition, the selection unit 116 may carry out calibration based on a history of input information and select one out of the plurality of buttons based on the result of the calibration.

The application executing unit 114 executes an application based on the button selected by the selection unit 116. As one example, in the case shown in FIGS. 1 and 2, part of the executed application may differ when the button A has been selected and when the button B has been selected by the selection unit 116. As described above, there are no particular limitations on the type of application. The application executing unit 114 outputs the execution result of the application to the display control unit 115.

The display control unit 115 controls the display unit 140 so that various buttons are displayed on the display unit 140. In the example shown in FIGS. 1 and 2, the button A, the button B, the button C, and the button D are displayed by the display unit 140. Also, based on the execution result outputted from the application executing unit 114, the display control unit 115 may control the display unit 140 so that an application execution screen is displayed by the display unit 140. Note that as described above, the application execution screen may be displayed by a different display unit to the display unit 140.

In accordance with control by the display control unit 115, the display unit 140 displays various buttons. Also in accordance with control by the display control unit 115, the display unit 140 may display an application execution screen. However, the application execution screen may be displayed by a different display unit to the display unit 140. As described above, the display unit 140 may be provided in the information processing apparatus 10 or may be present outside the information processing apparatus 10. Note that the display unit 140 is constructed for example of an LCD (Liquid Crystal Display) or an organic LE (ElectroLuminescence) display apparatus.

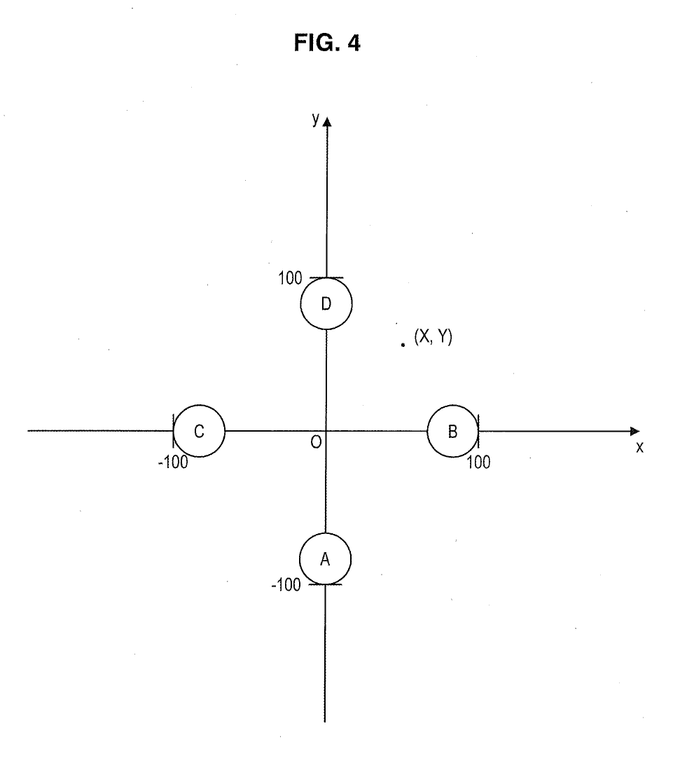

FIG. 4 is a diagram showing an example layout of a plurality of buttons by the information processing apparatus 10 according to the present embodiment. FIG. 4 shows an example of coordinate axes (an x axis and a y axis) set on the touch panel 130 for a case where a plurality of buttons are laid out as shown in FIGS. 1 and 2. The contact position of the input object is shown as (X, Y). Although the center of the buttons is the origin (0,0), the position of the lower end of the button A is (0,−100), the position of the right end of the button B is (100,0), the position of the left end of the button C is (−100,0), and the position of the upper end of the button D is (0,100) in the example shown in FIG. 4, the setting of the coordinate axes is not particularly limited to such.

The method by which the selection unit 116 selects a button will now be described in detail. Here, a case where x and y coordinates are set on the touch panel 130 as shown in FIG. 4 will be described as one example. However, the setting of the x and y coordinates is not especially limited to such. Note that the meanings of the respective symbols used in the following description are given below.

X: x coordinate of contact position

Y: y coordinate of contact position

S: Contact area (where the area of each button is set at “1”)

P: Pressure (where the maximum pressure that can be detected by the touch panel is set at “1”)

S: Contact area after correction according to pressure

Q(A), Q(B), Q(C), Q(D): coefficients provided for each button

The method of selecting a button described below mainly calculates a score for each button by multiplying a “value calculated from the contact position” and a “coefficient Q calculated based on the type of touch” and determines that the button with the highest score is the button that the user is attempting to press. The “value calculated from the contact position” is higher the closer a button is positioned to the contact position. If contact has been made with the tip of the finger, for example, the “coefficient Q calculated based on the type of touch” is higher for buttons pressed with the tip of the finger compared to buttons pressed with the pad of the finger. The coefficient Q corresponds to one example of a “parameter” for the present disclosure.

Although the area of each button is set at “1” here, the area of each button is not particularly limited to such. Also, although the maximum pressure that can be detected by a touch panel is set at “1”, the maximum pressure that can be detected by a touch panel is not particularly limited to such. In the following description, as one example, the button A and the button B are buttons pressed with the tip of the finger and the button C and the button D are buttons pressed with the pad of the finger.

As described above, the selection unit 116 may select one out of the plurality of buttons based on the contact position (X, Y), the contact area S, and the pressure P. As one example, the selection unit 116 may correct the contact area S using the pressure P and select one out of the plurality of buttons based on the contact position (X, Y) and the corrected contact area S′. In more detail, the selection unit 116 may correct the contact area S so that the larger the pressure P, the smaller the corrected contact area S′. The contact area S is corrected in this way because when the pressure is large, an increase in the contact area is also expected, resulting in the possibility of mistakenly determining that the touch panel was contacted by the pad of the finger even though the touch panel was contacted by the tip of the finger.

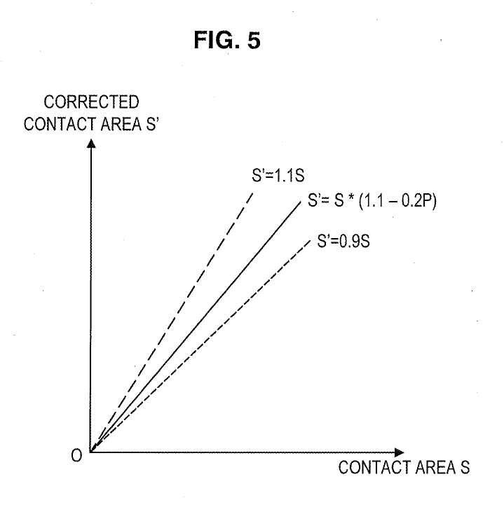

FIG. 5 is a diagram showing an example correction of the contact area by the selection unit 116. As shown in FIG. 5, as one example the selection unit 116 is capable of calculating the corrected contact area S′ based on Equation (1) given below.

S′=S*(1.1−0.2P) (1)

Note that although “1.1” and “0.2” are used as constants in Equation (1), it is possible to change such constants as appropriate. For example, if the corrected contact area S′ has been calculated based on Equation (1), as shown in FIG. 5, the closer the pressure P is to zero (i.e., the smaller the pressure), the closer the value used to multiply the contact area S in order to calculate the corrected contact area S′ will be to “1.1”. Also, the closer the pressure to “1” (i.e., the larger the pressure), the closer the value used to multiply the contact area S in order to calculate the corrected contact area S′ is to “0.9”.

Also, when pressure is not especially used, it is possible to use the contact area S in place of the corrected contact area S′. Next, the selection unit 116 calculates the coefficients Q associated with the respective buttons. As described above, the coefficients Q are examples of parameters used to select a button. That is, the selection unit 116 may calculate other parameters in place of the coefficient Q.

For example, on determining from the corrected contact area S′ that the user has pressed with the tip of the user's finger, the selection unit 116 may calculate the coefficients of buttons pressed by the tip of the finger as higher values than the coefficients of buttons pressed by the pad of the finger. For example, on determining from the corrected contact area S′ that the user has pressed with the tip of his/her finger, the selection unit 116 may calculate the coefficients of buttons pressed by the pad of the finger as higher values than the coefficients of buttons pressed by the tip of the finger.

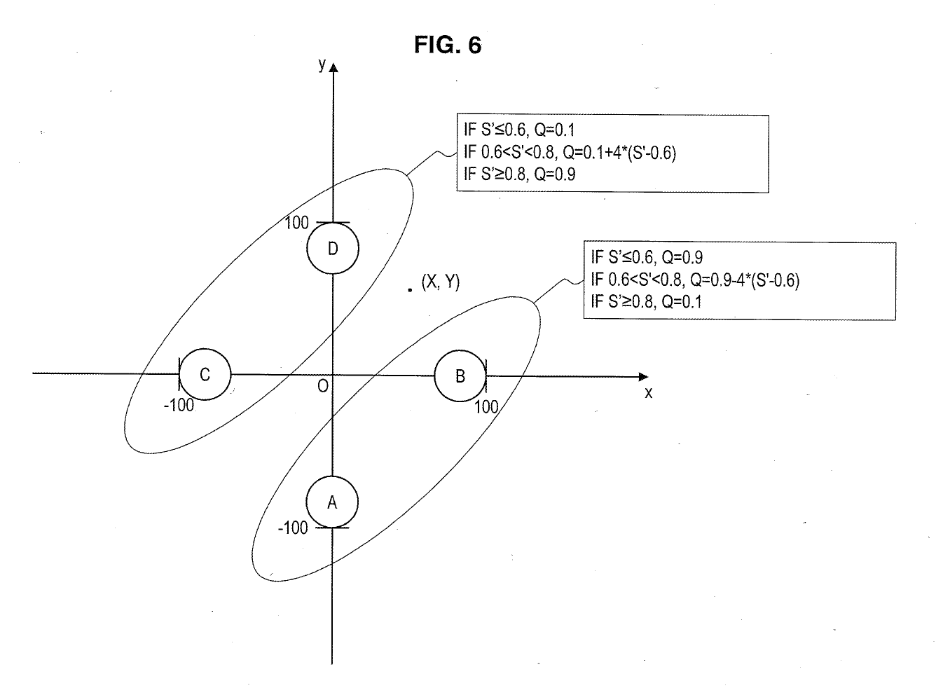

FIG. 6 is a diagram showing an example of how the coefficients that correspond to the respective buttons are decided. As one example, on determining from the corrected contact area S′ that the user has pressed with the tip of his/her finger (in the example shown in FIG. 6, when the corrected contact area S′ is “0.6” or below), the selection unit 116 may calculate the coefficients Q(A), Q(B) of the buttons pressed with the tip of the finger as higher values and calculate the coefficients Q(C), Q(D) of the buttons pressed with the pad of the finger as lower values. If the coefficients are calculated in this way, it is believed that the coefficients Q have a larger influence on the scores.

Meanwhile, on determining from the corrected contact area S′ that the user has pressed with the pad of his/her finger (in the example shown in FIG. 6, when the corrected contact area S′ is at least “0.8”), the selection unit 116 may calculate the coefficients Q(C), Q(D) of the buttons pressed with the pad of the finger as higher values and calculate the coefficients Q(A), Q(B) of the buttons pressed with the tip of the finger as lower values. If the coefficients are calculated in this way, it is believed that the coefficients Q will have a larger influence on the scores.

If it is difficult to determine from the corrected contact area S′ whether the user has pressed with the pad of his/her finger or with the pad of his/her finger (in the example shown in FIG. 6, when the corrected contact area S′ is above “0.6” but below “0.8”), the selection unit 116 may calculate the various coefficients so that the difference between the coefficients Q(A), Q(B) of the buttons pressed with the tip of the finger and the coefficients Q(C), Q(D) of the buttons pressed with the pad of the finger becomes smaller. If the coefficients are calculated in this way, it is believed that the coefficients Q will have a smaller influence on the scores. In the example shown in FIG. 6, the selection unit 116 calculates the coefficients Q of the respective buttons as shown in Equations (2) to (7) below.

For the coefficients Q(A), Q(B) of the buttons pressed with the tip of the finger,

if the corrected contact area S′ is “0.6” or smaller,

Q=0.9 (2)

if the corrected contact area S′ is “0.8” or larger,

Q=0.1 (3)

if the corrected contact area S′ is larger than “0.6” but smaller than “0.8”,

Q=0.9−4*(S′−0.6) (4)

For the coefficients Q(C), Q(D) of the buttons pressed with the pad of the finger,

if the corrected contact area S′ is “0.6” or smaller,

Q=0.1 (5)

if the corrected contact area S′ is “0.8” or larger

Q=0.9 (6)

if the corrected contact area S′ is larger than “0.6” but smaller than “0.8”,

Q=0.1−4*(S′−0.6) (7)

Note that it should be obvious that the calculation of the coefficients Q is not limited to calculation based on Equations (2) to (7). As one example, although the threshold for determining whether the user has pressed with the tip of his/her finger is set at “0.6” in Equations (2) to (7), the threshold may be set at a different value. Also, although the threshold for determining whether the user has pressed with the pad of his/her finger is set at “0.8” in Equations (2) to (7), the threshold may be set at a different value. There is also no particular limitation on the number of coefficients.

Next, the selection unit 116 calculates scores corresponding to the respective buttons based on the contact position (X, Y) and the coefficients corresponding to the respective buttons. For example, it is possible for the selection unit 116 to calculate the score of each button by multiplying the distance from the contact position (X, Y) to the position of the button by the coefficient of the button. Alternatively, the selection unit 116 may calculate the score of each button based on Equations (8) to (11) below, where |X| is the absolute value of X.

Score of button A=(100−Y*|Y|)*Q(A) (8)

Score of button B=(100+X*|X|)*Q(B) (9)

Score of button C=(100−X*|X|)*Q(C) (10)

Score of button D=(100+Y*|Y|)*Q(D) (11)

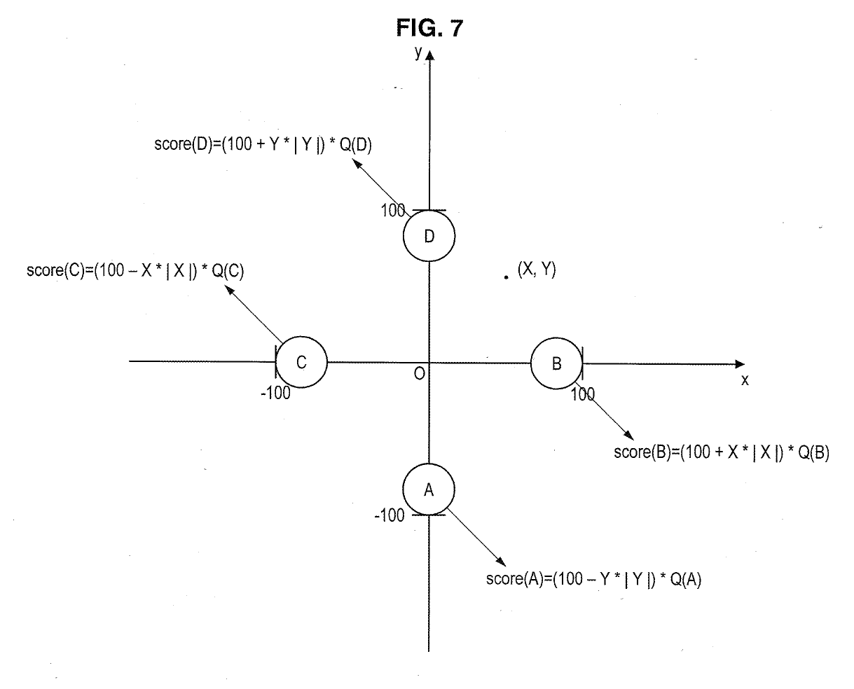

FIG. 7 is a diagram showing one example of calculation of scores corresponding to the respective buttons. FIG. 7 shows an example case where the selection unit 116 calculates the scores of the buttons based on Equations (8) to (11). Here, as one example, in Equation (8) for calculating the score of button A, the value calculated from the contact position is set as (100−Y*|Y|). This expression reflects the following intentions.

Since the contact position becomes closer to the button A placed at the bottom as the value of Y decreases, the score of the button increases.

X is considered when calculating the scores of the buttons B and C, and since it is necessary to compare the score of the button A with such scores, X is not considered when calculating the score of the button A.

When Y is a certain value or higher, to prioritize the coordinate information over the type of touch on the touch panel, Y is multiplied by itself.

When Y is approximately zero, since it is not important whether Y is “−0.001” or “0.001” for example, “100” is added to prevent the score from easily becoming negative (if “100” were not added, the score would become negative when Y is a small positive value regardless of the value of Q, and hence, such calculation is prevented from being performed).

Similar intentions apply to the calculation of the scores of buttons B, C, and D. Here, examples are shown of how the selection unit 116 calculates the scores of the respective buttons and determines which button has been pressed based on such scores for a case where the calculation method for the scores described above is used and the various values shown in Input Example 1 and Input Example 2 below have been inputted. Note that the selection unit 116 selects the button with the highest score out of the scores of the respective buttons.

Input Example 1: X=10, Y=5, S=0.5, P=0.5

Calculation result: S′=0.5*(1.1−0.2*0.5)=0.5

Type of Touch: Determined to be pressing with the tip of the finger

Coefficients: Q(A), Q(B)=0.9
Q(C), Q(D)=0.1

Score of button A: (100−Y*|Y|)*Q=(100−5*|5|)*0.9=67.5

Score of button B: (100+X*|X|)*Q=(100+10*10)*0.9=180

Score of button C: (100−X*|X|)*Q=(100−10*10)*0.1=0

Score of button D: (100+Y*|Y|)*Q=(100+5*|5|)*0.1=7.5

Determination result: Determine that button B has been pressed

(i.e., the contact position and the type of touch on the touch panel both indicate a high probability that the user wished to press button B).

Input Example 2: X=10, Y=5, S=0.8, P=0.5

Calculation result: S′=0.8*(1.1−0.2*0.5)=0.8

Type of Touch: Determined to be pressing with the pad of the finger

Coefficients: Q(A), Q(B)=0.1
Q(C), Q(D)=0.9

Score of button A: (100−Y*|Y|)*Q=(100−5*|5|)*0.1=7.5

Score of button B: (100+X*|X|)*Q=(100+10*10)*0.1=20

Score of button C: (100−X*|X|)*Q=(100−10*10)*0.9=0

Score of button D: (100+Y*|Y|)*Q=(100+5*|5|)*0.9=112.5

Determination result: Determine that button D has been pressed

(i.e., although the contact position is close to button B, when the type of touch on the touch panel is considered, it is determined that there is a high probability that the user wished to press button D).

This completes the description of the selection of a button by the selection unit 116. By selecting a button in this way, it is possible to improve the accuracy when selecting the user's intended button. In addition, as described above, it is also possible to improve the accuracy of determinations by using characteristic information for an individual user and/or characteristic information for various usage states acquired by carrying out calibration. That is, the selection unit 116 is capable of selecting one out of a plurality of buttons based on the contact position detected by the position detecting unit 111, the contact area detected by the area detecting unit 113, and a contact history for when the input object has contacted the touch panel 130.

Although there are no particular limitations on the contact history, as one example the contact history may include a history of contact positions detected in the past by the position detecting unit 111. In this case, as one example the selection unit 116 corrects the contact position detected by the position detecting unit 111 based on the history of contact positions and selects one out of the plurality of buttons based on the contact area detected by the area detecting unit 113 and the corrected contact position. Such correction may be carried out for each button that has been selected by previous contact.

In more detail, as one example, if one or a plurality of contact positions has/have been detected in the past, the selection unit 116 may calculate a displacement between an average value of such one or plurality of contact positions and the positions of the buttons selected by such contact and carry out correction by shifting the contact position (X, Y) by such displacement.

The contact history may also include a history of contact areas detected in the past by the area detecting unit 113. In such case, as one example the selection unit 116 may correct the contact area detected by the area detecting unit 113 based on the history of contact areas and select one out of the plurality of buttons based on the contact position detected by the position detecting unit 111 and the corrected contact area. Such correction may be carried out for each button that has been selected by previous contact.

In more detail, as one example, one or a plurality of contact areas has/have been detected in the past, the selection unit 116 may calculate an average value of such one or plurality of contact areas and carry out correction of the contact area in accordance with such average value. As one example, if such average value exceeds a range of contact areas that has been decided in advance (for example, the range of contact areas for when a touch panel is touched by a typical user), the selection unit 116 may carry out correction so as to reduce the contact area. Conversely, if for example the average value is below the range of contact areas that has been decided in advance, the selection unit 116 may carry out correction to increase the contact area.

As one example, the selection unit 116 may carry out correction of the thresholds corresponding to the respective buttons out of the plurality of buttons based on the history of the contact area and select one out of the plurality of buttons based on the contact position, the contact area, and the corrected thresholds.

More specifically, if as one example, one or a plurality of contact areas has/have been detected in the past, the selection unit 116 may calculate an average value of the one or plurality of contact areas and correct the thresholds in accordance with such average value. For example, if the average value exceeds the range of contact areas decided in advance, the selection unit 116 may carry out correction so as to increase at least one out of a threshold for determining that the user has pressed with the pad of his/her finger and a threshold for determining that the user has pressed with the tip of his/her finger. Conversely, if for example the average value is below the range of contact areas decided in advance, the selection unit 116 may carry out correction so that at least one out of such thresholds is reduced.

The contact history may also include a history of the pressure detected in the past by the pressure detection unit 112, for example. In such case, as one example, the selection unit 116 may carry out correction of the contact area detected by the area detecting unit 113 based on the history of the pressure and select one out of the plurality of buttons based on the contact position detected by the position detecting unit 111 and the corrected contact area. Such correction may be carried out for each button that has been selected by previous contact.

More specifically, if as one example, one or a plurality of pressures has/have been detected in the past, the selection unit 116 may calculate an average value of the one or plurality of pressures and correct the contact area in accordance with such average value. As one example, if the average value exceeds a range of pressures decided in advance (for example, a range of pressures for when a touch panel is touched by a typical user), since it is believed that this will result in a larger contact area, the selection unit 116 may carry out correction so as to reduce the contact area. Conversely, if for example the average value falls below the range of pressures decided in advance, since it is believed that this will result in a smaller contact area, the selection unit 116 may carry out correction so as to increase the contact area.

As another example, the selection unit 116 may carry out correction of the thresholds associated with the respective buttons out of the plurality of buttons based on a history of pressure and select one out of the plurality of buttons based on the contact position, the contact area, and the corrected thresholds.

As a specific example, if one or a plurality of pressures has/have been detected in the past, the selection unit 116 may calculate an average value of such one or plurality of pressures and correct the thresholds in accordance with such average value. If for example such average value exceeds a range of pressures decided in advance, the selection unit 116 may carry out correction so that at least one of the threshold for determining if the user has pressed with the pad of his/her finger and the threshold for determining if the user has pressed with the tip of his/her finger is increased. Conversely, if for example the average value falls below the range of pressures decided in advance, the selection unit 116 may carry out correction so that at least one of such thresholds is decreased.

This completes the description of the functions of the information processing apparatus 10 according to the present embodiment of the disclosure. Next, the operation of the information processing apparatus 10 according to the present embodiment will be described.

### 3. Operation of Information Processing Apparatus

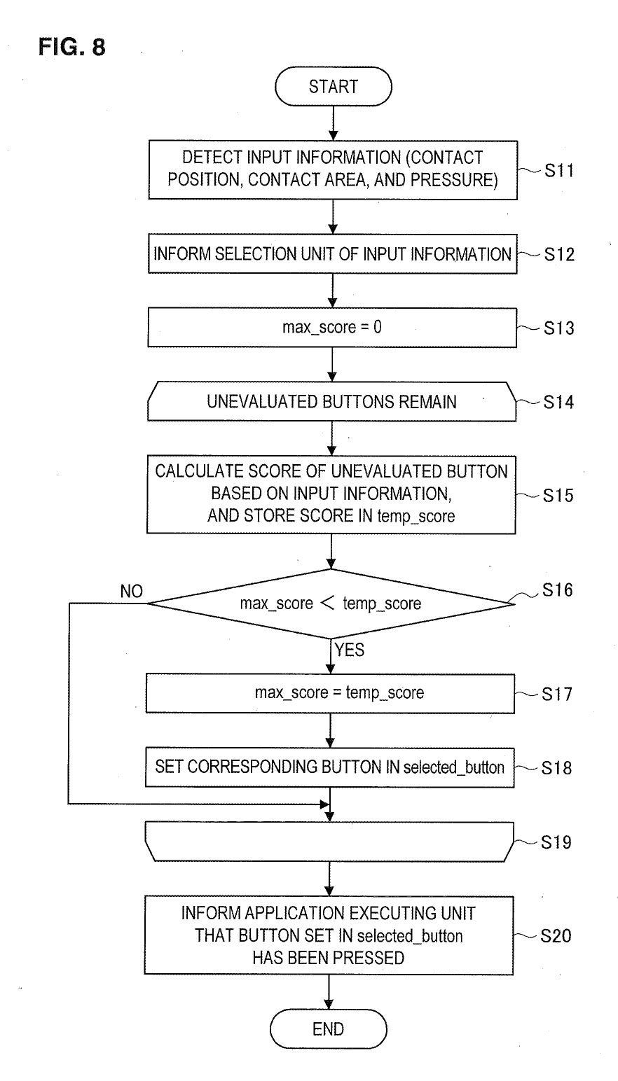

FIG. 8 is a flowchart showing the flow of operation by the information processing apparatus 10 according to the present embodiment of the disclosure. Note that the operation shown in FIG. 8 is merely one example of the operation of the information processing apparatus 10 and that the operation of the information processing apparatus 10 is not limited to the flow of operation shown in FIG. 8.

First, the information processing apparatus 10 detects the input information (contact position, contact area, and pressure) (S11). More specifically, the position detecting unit 111 detects the contact position of the input object on the touch panel 130, the pressure detection unit 112 detects the pressure of the input object on the touch panel 130, and the area detecting unit 113 detects the contact area for the input object on the touch panel 130. The selection unit 116 is then informed of such input information (S12). The selection unit 116 stores “0” in a variable max_score (S13) and S14 to S19 are repeated until no more unevaluated buttons are left.

The selection unit 116 calculates a score of an unevaluated button based on the input information and stores the calculated store in the variable temp_score (S15). If the value stored in the variable temp_score is not larger than the value stored in the variable max_score (“No” in S16), the selection unit 116 returns to S14. Meanwhile, if the value stored in the variable temp_score is larger than the value stored in the variable max_score (“Yes” in S16), the selection unit 116 stores the value of the variable temp_score in the variable max_score (S17), sets the corresponding button in the variable selected_button (S18), and then returns to S14.

If no unevaluated buttons are left, the selection unit 116 informs the application executing unit 114 that the buttons set in the variable selected_button has been pressed (S20). Note that the application executing unit 114 has an application executed in accordance with the pressed button. Also, as described above, the contact history may be used when calculating the scores.

This completes the description of the operation of the information processing apparatus 10 according to the present embodiment of the disclosure. Here, as one example, even when the user is actually looking at a touch panel, if a large number of keys are laid out in a limited area as with a software keyboard, a phenomenon can occur where the user presses a button that the user did not intend to press. The following describes a method for avoiding such phenomenon.

### 4. Another Example of Functions of Information Processing Apparatus

To avoid the phenomenon described above, different parameters to neighboring buttons may be associated with respective buttons out of the plurality of buttons and the selection unit 116 may select one out of the plurality of buttons based on the parameters associated with the respective buttons out of the plurality of buttons, the contact position, and the contact area. So long as such parameters have values that are used in selecting a button, there are no particular limitations on the parameters and as one example, the coefficients described above may be used.

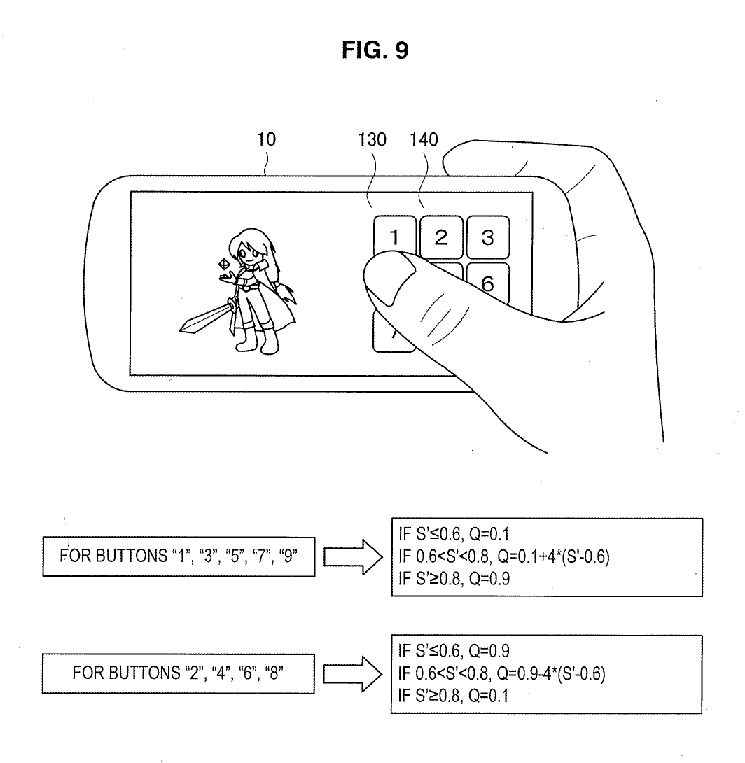

FIG. 9 is a diagram showing another example of deciding the coefficients corresponding to respective buttons. As one example, if the buttons “1” to “9” are present on the touch panel 130 as shown in FIG. 9, as described above a phenomenon where the user presses a button that the user did not intend to press may occur. For this reason, as one example the coefficient Q of buttons pressed with the pad of the finger may be associated with the plurality of buttons “1”, “3”, “5”, “7”, and “9” that are not adjacent to one another, and the coefficient Q of buttons pressed with the tip of the finger may be associated with the plurality of buttons “2”, “4”, “6”, and “8” that are not adjacent to one another. However, the coefficients associated with the respective buttons are not limited to the example shown in FIG. 9.

The selection unit 116 may select one out of a plurality of buttons based on the coefficients Q associated with the respective buttons out of the plurality of buttons, the contact position, and the contact area. As one example, if the coefficients are associated with the respective buttons as shown in FIG. 9, the score of each button may be calculated based on the respective coefficients Q associated with such buttons out of the plurality of buttons and the contact area, and one out of the plurality of buttons may be selected based on the calculated score and the contact position.

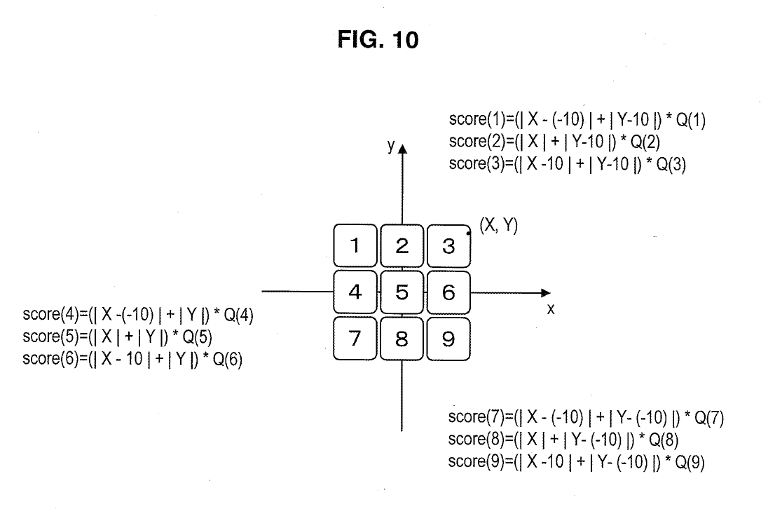

FIG. 10 is a diagram showing another example of calculation of scores corresponding to the respective buttons. If the coefficients Q are associated with the respective buttons as shown in FIG. 9, the selection unit 116 is capable of calculating the score of each button based on such coefficients Q associated with such buttons and the contact position. The selection unit 116 is also capable of selecting the button with the highest score out of the scores of the respective buttons. However, since the example shown in FIG. 10 is merely one example of the calculation of scores of the respective buttons, the calculation of the scores of buttons is not limited to this example.

### 5. Conclusion

As described above, according to an embodiment of the present disclosure there is provided the information processing apparatus 10 including the position detecting unit 111 that detects the contact position of an input object on the touch panel 130, the area detecting unit 113 that detects the contact area of the input object on the touch panel 130, and the selection unit 116 that selects one out of a plurality of objects based on the contact position and the contact area.

With the above configuration, since the contact area between the touch panel 130 and the input object is also considered when selecting one out of a plurality of objects, it is possible to improve the accuracy when selecting the user's intended object. For example, if the user operates the touch panel without looking at the objects themselves, there is a high probability that the user's intended object will be selected even if a position displaced from a recognition region is touched. A further effect is expected in that it also becomes unnecessary for the user to momentarily look at the controller when the user is making operations on a touch panel.

The technology according to an embodiment of the present disclosure differs to existing technology. As one example, there is a technology for expanding the recognition region of a button laid out on a touch panel if a position slightly outside such button is selected with high frequency (see, for example, Japanese Laid-Open Patent Publication No. 2009-31914). However, since it is necessary, when a touch panel is used as a controller for example, for the user to press buttons without looking at the touch panel, there are cases where the user presses a region aside from a region slightly outside a button (for example, a middle position between buttons). In such case, it is difficult to recognize the pressing of a button as intended by the user.

As another example, there is also a technology for moving a recognition region of each button in accordance with a home position of the user (see, for example, Japanese Laid-Open Patent Publication No. 2010-66899). With this technology, if for example there are four buttons, a home position is set at the center of such four buttons. However, when a keyboard is used, as one example the number of fingers placed at the home position is as many as eight. In addition, bumps can be provided at keys where the index fingers are positioned, so that it is expected that the user's fingers will rarely become displaced from the home position during operations.

Meanwhile, when a controller is used, as one example the fingers to be placed at the home positions are just the two thumbs with which it is necessary to carry out most input operations. This means that if consecutive inputs are to be made, in many cases the inputting will continue without the fingers returning to the home position. Since displacements will increase if operations continue without the fingers using the home position as a starting point, even if the recognition regions of the buttons are shifted in accordance with the home position, there will still be cases where a position between a plurality of recognition regions is pressed. In such case, it is difficult to determine which button was pressed.

In addition, although the home position should preferably be indicated to the user via the sense of touch, such ability is limited to devices capable of giving such a sensory indication. Although it would be possible to attach stickers or the like to a terminal with a touch panel and give a sensory indication via such stickers, in many cases the terminals in question will not be primarily used as controllers. As one example, when such a device is used as a multi-purpose terminal, it is necessary to consider uses aside from use as a controller and therefore undesirable to attach stickers to the terminal.

It should be understood by those skilled in the art that various modifications, combinations, sub-combinations and alterations may occur depending on design requirements and other factors insofar as they are within the scope of the appended claims or the equivalents thereof.

The steps in the operation of the information processing apparatus 10 according to the embodiment described above also do not have to be executed in a time series in the order indicated in the flowchart. For example, the steps in the operation of the information processing apparatus 10 may be executed in a different order to the order indicated in the flowchart or may be executed in parallel.

It is also possible to generate a computer program for causing hardware, such as a CPU, ROM, and RAM incorporated in the information processing apparatus 10, to realize the same functions as the configuration of the information processing apparatus 10 described above. A storage medium that stores such computer program may also be provided.

Additionally, the present technology may also be configured as below.
(1) An information processing apparatus including:

a position detecting unit detecting a contact position at which an input object has touched a touch panel;

an area detecting unit detecting a contact area between the touch panel and the input object; and

a selecting unit selecting any one of a plurality of objects based on the contact position and the contact area.
(2) The information processing apparatus according to (1), further including:

a pressure detecting unit detecting pressure applied by the input object onto the touch panel, and

wherein the selecting unit selects any one of the plurality of objects further based on the pressure.
(3) The information processing apparatus according to (2),

wherein the selecting unit corrects the contact area using the pressure and selects any one of the plurality of objects based on the contact position and the corrected contact area.
(4) The information processing apparatus according to (3),

wherein the selecting unit corrects the contact area in a manner that the contact area decreases with increase in the pressure.
(5) The information processing apparatus according to any one of (1) to (4),

wherein the selecting unit selects any one of the plurality of objects further based on a contact history at a time when the input object contacted the touch panel.
(6) The information processing apparatus according to (5),

wherein the contact history includes a history of the contact position previously detected by the position detecting unit.
(7) The information processing apparatus according to (6),

wherein the selecting unit corrects the contact position detected by the position detecting unit based on the history of the contact position and selects any one of the plurality of objects based on the contact area and the corrected contact position.
(8) The information processing apparatus according to (6),

wherein the contact history includes a history of the contact area previously detected by the area detecting unit.
(9) The information processing apparatus according to (8),

wherein the selecting unit corrects the contact area detected by the area detecting unit based on the history of the contact area and selects any one of the plurality of objects based on the contact position and the corrected contact area.
(10) The information processing apparatus according to (8),

wherein the selecting unit corrects a threshold associated with each of the plurality of objects based on the history of the contact area and selects any one of the plurality of objects based on the contact position, the contact area, and the corrected threshold.
(11) The information processing apparatus according to (5),

wherein the contact history includes a history of the pressure previously detected by the pressure detecting unit.
(12) The information processing apparatus according to (11),

wherein the selecting unit corrects the contact area detected by the area detecting unit based on the history of the pressure and selects any one of the plurality of objects based on the contact position and the corrected contact area.
(13) The information processing apparatus according to (11),

wherein the selecting unit corrects a threshold associated with each of the plurality of objects based on the history of the pressure and selects any one of the plurality of objects based on the contact position, the contact area, and the corrected threshold.
(14) The information processing apparatus according to (1),

wherein each of the plurality of objects is associated with a parameter different from a neighboring object, and

the selecting unit selects any one of the plurality of objects based on the parameter associated with each of the plurality of objects, the contact position, and the contact area.
(15) An information processing method including:

detecting a contact position at which an input object has touched a touch panel;

detecting a contact area between the touch panel and the input object; and

selecting any one of a plurality of objects based on the contact position and the contact area.
(16) A program for causing a computer to function as an information processing apparatus, the information processing apparatus including

a position detecting unit detecting a contact position at which an input object has touched a touch panel,

an area detecting unit detecting a contact area between the touch panel and the input object, and

a selecting unit selecting any one of a plurality of objects based on the contact position and the contact area.

The present disclosure contains subject matter related to that disclosed in Japanese Priority Patent Application JP 2012-021891 filed in the Japan Patent Office on Feb. 3, 2012, the entire content of which is hereby incorporated by reference.

What is claimed is:

1. An information processing apparatus comprising:
a position detecting unit detecting a contact position at which an input object has touched a touch panel;
an area detecting unit detecting a contact area between the touch panel and the input object; and
a selecting unit selecting any one of a plurality of objects based on the contact position and the contact area.

2. The information processing apparatus according to claim 1, further comprising:
a pressure detecting unit detecting pressure applied by the input object onto the touch panel, and
wherein the selecting unit selects any one of the plurality of objects further based on the pressure.

3. The information processing apparatus according to claim 2,
wherein the selecting unit corrects the contact area using the pressure and selects any one of the plurality of objects based on the contact position and the corrected contact area.

4. The information processing apparatus according to claim 3,
wherein the selecting unit corrects the contact area in a manner that the contact area decreases with increase in the pressure.

5. The information processing apparatus according to claim 1,
wherein the selecting unit selects any one of the plurality of objects further based on a contact history at a time when the input object contacted the touch panel.

6. The information processing apparatus according to claim 5,
wherein the contact history includes a history of the contact position previously detected by the position detecting unit.

7. The information processing apparatus according to claim 6,
wherein the selecting unit corrects the contact position detected by the position detecting unit based on the history of the contact position and selects any one of the plurality of objects based on the contact area and the corrected contact position.

8. The information processing apparatus according to claim 5,
wherein the contact history includes a history of the contact area previously detected by the area detecting unit.

9. The information processing apparatus according to claim 8,
wherein the selecting unit corrects the contact area detected by the area detecting unit based on the history of the contact area and selects any one of the plurality of objects based on the contact position and the corrected contact area.

10. The information processing apparatus according to claim 8,
wherein the selecting unit corrects a threshold associated with each of the plurality of objects based on the history of the contact area and selects any one of the plurality of objects based on the contact position, the contact area, and the corrected threshold.

11. The information processing apparatus according to claim 5,
wherein the contact history includes a history of the pressure previously detected by the pressure detecting unit.

12. The information processing apparatus according to claim 11,
wherein the selecting unit corrects the contact area detected by the area detecting unit based on the history of the pressure and selects any one of the plurality of objects based on the contact position and the corrected contact area.

13. The information processing apparatus according to claim 11,
wherein the selecting unit corrects a threshold associated with each of the plurality of objects based on the history of the pressure and selects any one of the plurality of objects based on the contact position, the contact area, and the corrected threshold.

14. The information processing apparatus according to claim 1,
wherein each of the plurality of objects is associated with a parameter different from a neighboring object, and
the selecting unit selects any one of the plurality of objects based on the parameter associated with each of the plurality of objects, the contact position, and the contact area.

15. An information processing method comprising:
detecting a contact position at which an input object has touched a touch panel;
detecting a contact area between the touch panel and the input object; and
selecting any one of a plurality of objects based on the contact position and the contact area.

16. A program for causing a computer to function as an information processing apparatus, the information processing apparatus including
a position detecting unit detecting a contact position at which an input object has touched a touch panel,
an area detecting unit detecting a contact area between the touch panel and the input object, and
a selecting unit selecting any one of a plurality of objects based on the contact position and the contact area.
